(19) United States
(12) Patent Application Publication
(10) Pub. No.: US 2005/0136159 A1
(43) Pub. Date: Jun. 23, 2005

(54) Microwavable frozen garden salad entrees

(76) Inventors: Pauline Susan Avery, Ray, OH (US); Anne Marie Draper, Jackson, OH (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/957,207

(22) Filed: Sep. 30, 2004

Related U.S. Application Data
(60) Provisional application No. 60/507,281, filed on Sep. 30, 2003.

(51) Int. Cl. A23L 3/00

(52) U.S. Cl. 426/241

(57) ABSTRACT

The present invention relates to frozen entrées comprising vegetables and a dressing that when combined together deliver the consistency and flavor expected. Moreover the entrées of the present invention include a stabilizer such as a matrix of gums and starch that allow for the creation of a dressing to utilize the moisture and vapor created when microwaving frozen vegetables and other toppings.

### RELATED APPLICATIONS

This application claims priority to U.S. Provisional Patent Application Ser. No. 60/507,281 for Microwavable Frozen Garden Salad Entrees, filed Sep. 30, 2003, the contents of which is hereby incorporated by reference.

### FIELD OF THE INVENTION

The present invention relates to frozen entrées comprising vegetables and a dressing that when combined together deliver desirable consistency and flavor. Moreover, the entrées of the present invention include a stabilizer such as a matrix of gums and starches that allow for a dressing to utilize the moisture created when microwaving frozen vegetables and other toppings.

### BACKGROUND OF THE INVENTION

The convenience of frozen entrées has provided a simple and quick alternative for individuals and families with active schedules. Many frozen entrées utilize a limited amount of vegetables in their food combinations since their cooking properties are difficult to control and they tend to hold large amounts of water when frozen. When thawed, the high water content can damage the frozen entrées, especially with regards to the sauce or dressing consistency.

Further, frozen entrées generally are required to be heated to a relatively high temperature to eradicate bacteria or other harmful substances from the entrées. For food safety reasons, other frozen entrees must be cooked to at least 160 degrees. Typically, the packaging on frozen entrées warns consumers to “COOK THOROUGHLY”, and cooking instructions are developed to ensure the food is heated to at least 160 degrees before eating.

### SUMMARY OF THE INVENTION

Embodiments of the present invention relate to a frozen entrée consisting of vegetables and a dressing that when combined together deliver the consistency expected. Generally, the present invention is comprised substantially of vegetables that are mixed with a hydratable flavor base such as a sauce or dressing. Additionally, the present invention comprises a stabilizer such as a matrix of gums and starches that allow for the creation of a dressing to utilize the moisture and vapor created when microwaving frozen vegetables and other toppings to deliver a desired consistency. Further, the dressing may comprise a flavor base that is pumpable and manageable in a manufacturing environment.

The quality of the product of the present invention is dependent on the matrix of the flavor base to absorb moisture and coat the vegetables. In addition, the amount of moisture absorbed dictates the level of flavor concentration needed in the flavor base. Further, some vegetables provide more flavor in its juices than others. Therefore, some embodiments of the invention should take into account the positive and negative flavor contributions the vegetable juices themselves may contribute to the overall product.

The features and advantages of the invention will become apparent upon the review of the following detailed description of the presently preferred embodiment of the invention. It is understood that a wide range of changes and modifications can be made to the embodiment of the design. For example, different vegetables may be chosen for a specific entrée presentation that will require a specific modification to the stabilizers to deliver desired consistencies and flavors. It is therefore intended that the foregoing detailed description be regarded as illustrative rather than limiting and that it be understood that it is the following claims, including all equivalents thereof, which are intended to define the scope of the invention.

### DETAILED DESCRIPTION OF THE INVENTION

The microwavable frozen garden salad entrée of the present invention comprises frozen meals that can be eaten either hot or cold. Each entrée embodiment may comprise a special blend of vegetables and a uniquely flavored sauce or dressing. For example, the frozen entrée may comprise Mediterranean, Southwestern, Mandarin, Italian, Asian American, Greek, and other style salads. Unlike existing frozen entrées, there is no rice or pasta, or substantially no rice or pasta, in these entrées. Additionally, in various embodiments of the present invention, the entrées do not include meat or poultry. Therefore, the entrées of the present invention comprise predominantly vegetables and dressing, and may provide three full serving of vegetables, as defined by the USDA. Intended to be eaten as a single serving for lunch or a snack, they can also be served as a side dish for two or more.

In various embodiments of the present invention the dressing may be selected from a creamy dressing, glazing, sauce, dip, coating, and marinade. A creamy dressing may be defined as a substance that provides a light mouth feel with body, opaque appearance, and which coats vegetables. A glaze may be defined as a substance that provides a mouth feel that is slick or sticky with a translucent appearance that also coats vegetables. A sauce may be defined as a substance that provides a light mouth feel and has an opaque or translucent appearance.

The present invention generally is comprised substantially of vegetables that are mixed with a hydratable flavor base such as a sauce or dressing. In some embodiments, the present invention comprises at least about 60% vegetables, optionally at least about 70% vegetables, and further optionally at least about 80% vegetables. The entrées may also include some fruits, nuts and/or other garnishes. The vegetables are usually common garden vegetables including but not limited to cauliflower, tomatoes, potatoes such as roasted red potatoes; spinach; onions such as fire-roasted onions and minced onions; bell peppers; olives such as ripe, green or black; corn; jalapeno peppers; garlic cloves; carrots; beans such as kidney, green, black and wax; broccoli; baby corn; mushrooms; asparagus; peas; water chestnuts; pineapple; zucchini; artichoke hearts; mandarin oranges; raisins; dried fruit such as cranberries, cherries, bananas; chickpeas; and the like.

The hydratable flavor base provides several functions. For example, it provides flavor to the salad. In addition, the flavor base accommodates microwaving the entrée by promoting its properties and consistency to remain favorable despite the addition of water from the thawing vegetables. The flavor base generally comprises flavoring ingredients including but not limited to water, olive oil, salt, red wine vinegar, sugar, granulated garlic, Romano cheese, lemon juice powder, spices, natural vegetable gums (guar, xanthan, alginate), modified food starch, feta cheese, pasteurized milk and cream, cheese culture, stabilizers (xanthan and/or carob bean and/or guar gum), sour cream, white distilled vinegar, partially hydrogenated soybean oil, dehydrated minced onions, mustard flour, paprika, Dijon mustard, white wine, fruit pectin, citric acid, tartaric acid, honey cider vinegar, olive oil, soy sauce, sesame oil, brown sugar, rice wine vinegar, minced ginger, sesame seeds, Neufchatel cheese, starch such as modified corn starch, granulated onions, corn syrup solids, soy sauce solids, vegetable oils, tamarind, anchovy paste, apricots, artificial flavorings, potassium sorbate, sodium propionate, sodium benzoate, sulfur dioxide, orange concentrate and balsamic vinegar.

As previously suggested, the flavoring base is generally produced to interact with the water delivered by the vegetables during thawing. Moreover, the entrées of the present invention include a stabilizer such as a matrix of gum and/or starch that allows for the creation of a dressing to utilize the moisture and vapor created when microwaving frozen vegetables and other toppings.

Eliminating or utilizing the excess moisture obtained from heating frozen vegetables promotes a desired consistency of the entrée upon thawing. Without accounting for the moisture released by the vegetables during thawing, the entrée would have an excess of moisture. Starches and gums in the flavor base help to control viscosity, prevent syneresis, extend shelf-life, add mouthfeel, retard crystal growth, enhance pumpability, and resist shear, low pH, and microwave cooking.

Examples of stabilizers useful in the salad entrée system of the present invention generally are a blend of natural gums, such as guar, xanthan, and sodium alginate and/or a waxy maize modified food starch, and equivalents thereof. The proportion of these ingredients is tailored to impart the desired appearance and texture ranging from a glaze to a creamy dressing. In some embodiments, the salad entrées of the present invention generally utilize a flavor base that is comprised of about 0%-5% gums, and optionally about 0.2% to 1.5% gums. Further, the salad entrées of the present invention generally utilize a flavor base that is comprised of about 0%-10% starches, and optionally about 1% to 3% starches. In some embodiments, the salad entrées of the present invention generally utilize a flavor base that is comprised of approximately about 0.5%-7.5% gums and/or starches, optionally about 0.75%-5% and further optionally about 1%-3% (the indicated amounts are weight percentages of the gums/starches in relation to the entire flavor base composition).

The usage level of the stabilizers depends on the desired taste of the entrée, the type of vegetables in the salad, and/or the other components in the dressing. Onions and mushrooms, for example, exude more moisture compared to carrots or broccoli when heated, whereas potatoes absorb excess moisture present when heated. A dressing with cream cheese, added for flavor and texture, would impart a degree of stabilization of its own as well. The dressing amount is also limited by the amount of fat desired. Therefore, each salad type is unique in the amount of dressing and the level and proportion of stabilizer added, and the selection and quantity of thickeners and stabilizers is dependent on the type of vegetables present in the salad and the desired consistency.

Additionally, the weight percentage of dry ingredients relative to the entire flavor base content may provide beneficial properties in the salad entrées of the present invention. For example, dry ingredients, other than gums and starches, included in the flavor base may include but are not limited to salt, sugar, granulated garlic, Romano cheese, lemon juice powder, spices, feta cheese, dehydrated minced onions, mustard flour, paprika, brown sugar, minced ginger, sesame seeds, Neufchatel cheese, granulated onions, corn syrup solids, soy sauce solids, tamarind, anchovy paste, apricots, artificial flavorings, potassium sorbate, sodium propionate, sodium benzoate and any other dry spices or flavorings. Generally, embodiments of the salad entrées of the present invention utilize ingredients that comprise approximately 10-40% dry ingredients, optionally 15-35% and optionally 20-33% (the indicated amounts are weight percentages of the dry ingredients in relation to the entire flavor base composition).

The following table compares a typical salad dressing with one embodiment of a flavor base utilized in a salad entrée of the present invention, such as a Mediterranean or Greek style salad.

| | Typical | Salad Entrée |
|---|---|---|
| Ingredient | Italian Dressing | Flavor Base |
| Canola Oil | 51.85 | 35.00 |
| Vinegar | 43.00 | 20.00 |
| Garlic, gran | .80 | 2.40 |
| Dry Mustard | .76 | 2.20 |
| Salt | 1.40 | 6.00 |
| Basil, whole | .20 | .45 |
| Oregano, whole | .17 | .50 |
| Red Pepper, crushed | .22 | .45 |
| Sugar | 1.60 | 7.0 |
| Water | — | 18.06 |
| DS 101 (gums) | — | .75 |
| Ultrasperse M(starch) | — | 1.00 |
| | 100% | 100% |

In the example above, the flavor base embodiment of the present invention has a decrease in liquids of 20% with the addition of 1.75% stabilizers. Also, the levels of seasoning and flavors added to the flavor base of the present invention are greater than the typical dressing or sauce. In this embodiment, a three-fold concentration of the seasonings is utilized to impart flavor to the entire salad. In some embodiments, the amount of liquid the vegetables will contribute in a salad is approximately 3-15% of the total vegetable weight. Ingredient juices will vary from salad to salad, as noted above, and may further depend upon the amount of microwave time applied.

Regarding preparation of various embodiments of the present invention, the product may be purchased frozen, and prepared in at least the following three ways:
Heated in a microwave for approximately 1-3 minutes, stirred and eaten cold;
Heated in a microwave for approximately 3-4.5 minutes, stirred and eaten warm;
Allowed to thaw at room temperature, stirred and eaten as is.

For food safety reasons, traditional frozen entrées must be cooked to at least 160° F. The packaging on other frozen entrees typically warns consumers to “COOK THOROUGHLY”, and cooking instructions are developed to ensure the food is heated to greater than 160° F. before eating. Embodiments of the present invention, however, are designed to be eaten after a short heating (as distinguished from cooking) time in the microwave. In many embodiments of the present invention, the microwave preparation is necessary to thaw the product and bring it to a temperature pleasing to the consumer. Generally, the salads of the present invention are heated to a temperature of approximately less than about 125° F., optionally between about 35 and 100° F., and further optionally between about 45 and 65° F. In some embodiments, the salads of the present invention are heated in a microwave for less than about 5 minutes to bring them to a desired temperature.

As discussed above, the thawing process is also utilized to create the unique dressing. The moisture in the vegetables condenses as the vegetables thaw and blends with the concentrated flavor base deposited in the bottom of the container. When stirred, a unique dressing that flavors the product is created.

The present invention also includes a method of making any of the embodiments of the entrées described above. In one embodiment, the entrées are generally produced and prepared by depositing dressing flavor base into a container, depositing one or more vegetables and/or other toppings on top of the flavor base, sealing the product, freezing the product, and heating the product (e.g., by microwave). During the heating step, steam vapor condenses on vegetables and migrates towards the bottom of the container, and the flavor base begins to absorb the moisture. The method may also include mixing the vegetables and flavor base to allow the flavor base to further absorb moisture and coat the vegetables to produce a product comprising vegetables coated with dressing with little to no excess water remaining in the dish. In some embodiments, the product may be allowed to sit (e.g., for 1-2 minutes) to provide greater liquid absorption and equilibration.

The following examples disclose the ingredients included in a few embodiments of the present invention, and are not intended to limit the scope of the invention.

### EXAMPLE 1

### Bistro—Greek Style

Ingredients: roasted red potatoes (sodium acid pyrophosphate used to retain color), tomatoes, cauliflower, red bell peppers, dressing (water, olive oil, salt, red wine vinegar, sugar, granulated garlic, romano cheese [pasteurized part-skim cow's milk, cheese culture, salt, enzymes, cellulose powder], lemon juice powder [corn syrup, lemon juice, lemon oil], dehydrated minced onions, spices, 0.8% by weight of the dressing of natural vegetable gums [guar, xanthan, alginate], 2.1% by weight of the dressing of modified food starch), fire-roasted onions, spinach, black olives, feta cheese (pasteurized cow's milk, salt, cheese cultures, enzymes).

### EXAMPLE 2

### Bistro —Southwestern Style

Ingredients: corn and roasted corn, dressing (sour cream [milk, cream, stabilizer {modified food starch, disodium phosphate, guar gum, sodium citrate, carrageenan, locust bean gum}, nonfat milk solids, potassium sorbate {to maintain freshness}], water, white distilled vinegar, cream cheese flavor (dehydrated cream cheese [pasteurized milk and cream, cheese culture, salt, carob bean gum], nonfat dry milk, sodium phosphate), canola oil with BHA & BHT, salt, diced tomatoes [tomatoes, tomato juice, calcium chloride, citric acid], sugar, jalapeño peppers [with vinegar and salt], tomato paste, 1.5% by weight of the dressing of modified food starch, granulated garlic, granulated onion, spices [including mustard flour], 0.35% by weight of the dressing of natural vegetable gums [guar, xanthan, alginate], paprika), carrots, kidney beans (with water, salt, calcium chloride, disodium EDTA added as a preservative), red and green bell peppers, broccoli, cooked black beans, roasted onions, roasted baby corn.

### EXAMPLE 3

### Bistro American Style

Ingredients: roasted red potatoes (sodium acid pyrophosphate used to retain color), broccoli, carrots, red bell peppers, dressing (dijon mustards [distilled vinegar and water, mustard seed, salt, white wine, fruit pectin, citric acid, tartaric acid, sugar, spices], honey, cider vinegar, sugar, olive oil, soy sauce [water, soybeans, wheat, salt], salt, 1% by weight of the dressing of natural vegetable gums [guar, xanthan, alginate}, garlic powder, granulated onion), mushrooms, onions, asparagus.

### EXAMPLE 4

### Bistro Asian-Style

Ingredients: broccoli, carrots, sugar snap peas, mushrooms, dressing (soy sauce [water, soybeans, wheat, salt], sesame oil, honey, brown sugar, rice wine vinegar [water, rice], granulated garlic, minced ginger, salt, 1.3% by weight of the dressing of natural vegetable gums [guar, xanthan, alginate], spices [including mustard flour], sesame seeds, paprika), red bell peppers, water chestnuts, pineapple, onions, rice noodles (unbleached enriched flour [wheat flour, niacin, reduced iron, thiamine mononitrate, riboflavin, folic acid], partially hydrogenated soybean oil, rice flour, water, salt).

### EXAMPLE 5

### Antipasto Italiano Style

Ingredients: red bell peppers, broccoli, carrots, three-bean salad mix (green and wax beans, water, kidney beans, vinegar, sugar, onions, red peppers, salt, turmeric, natural flavors, garlic powder), cooked gnocchi (water, enriched durum flour [durum flour, niacin, ferrous sulfate, thiamine mononitrate, riboflavin, folic acid], potato granules [potatoes, mono and diglycerides, sodium acid pyrophosphate, sodium bisulfite and BHT added to preserve freshness], whole egg, salt), dressing (sour cream [milk, cream, stabilizer {modified food starch, disodium phosphate, guar gum, sodium citrate, carrageenan, locust bean gum}, nonfat milk solids, potassium sorbate {to maintain freshness}], red pepper puree, water, cream cheese flavor (dehydrated cream cheese [pasteurized milk and cream, cheese culture, salt, carob bean gum], nonfat dry milk, sodium phosphate), salt, canola oil with BHA & BHT, sugar, 2.65% by weight of the dressing of modified food starch, garlic, red wine vinegar, granulated garlic, spices, granulated onion, 0.35% by weight of the dressing of natural vegetable gums [guar, xanthan, alginate]), zucchini, roasted artichoke hearts.

### EXAMPLE 6

### Caesar Style

Ingredients: cauliflower, broccoli, red and green peppers. Salad dressing: [water, olive oil, sour cream (modified milk ingredients, modified corn starch, disodium phosphate, guar gum, sodium citrate, carrageenan, carob bean gum, potassium sorbate), sugar, romano cheese, parmesan cheese, salt, onions, red wine vinegar, lemon juice powder (corn syrup, lemon juice, lemon oil), cream cheese flavour (modified milk ingredients, salt), cheese flavour (parmesan cheese, modified milk ingredients, salt, lactic acid, citric acid), 2.4% by weight of the dressing of modified corn starch, anchovy paste (anchovies, salt, water), granulated garlic, spice, worcestershire sauce (vinegar, molasses, corn syrup, water, salt, caramel colour, garlic powder, sugar, spice, anchovies, tamarinds, flavour, sulphites), 1.2% by weight of the dressing of vegetable gums (guar gum, xanthan gum, sodium alginate)], roasted yellow peppers.

### EXAMPLE 7

### Mandarin Style

Ingredients: broccoli, carrots, red bell peppers, dressing (apricot filling [water, sugar, evaporated apricots, food starch-modified, corn syrup, 2% or less of artificial flavor, potassium sorbate, sodium propionate, sodium benzoate and sulfur dioxide {preservatives}, citric acid, yellow 6 and yellow 5], soy sauce [water, soybeans, wheat, salt], water, rice wine vinegar [water, rice], sesame oil, sugar, honey, orange icing [corn syrup, orange peel, sugar, concentrated orange juice, 2% or less of orange oil, pectin, sodium citrate, citric acid, phosphoric acid, sodium benzoate {preservative}, sodium erythorbate, yellow 5 and yellow 6], ginger, 0.3% by weight of the dressing of natural vegetable gums [guar, xanthan, alginate], granulated garlic, 1.2% by weight of the dressing of modified corn starch, salt), mandarin orange segments (with water and sugar), golden raisins (sulfur dioxide added as a preservative), sweetened dried cranberries (cranberries, sugar, sunflower oil).

### EXAMPLE 8

### Mediterranean Style

Ingredients: tomatoes, broccoli, cauliflower, carrots, zucchini, roasted red potatoes (contains sodium acid pyrophosphate), cooked couscous (wheat flour), red bell peppers, roasted eggplant, roasted red onions, chickpeas (garbanzo beans, water, salt, disodium EDTA), black olives. Salad dressing: canola oil (BHA, BHT), balsamic vinegar, water, sugar, salt, romano cheese, spice, garlic, 0.7% by weight of the dressing of modified corn starch, 0.7% by weight of the dressing of vegetable gums (guar gum, xanthan gum, sodium alginate).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations, which fall within the spirit and broad scope of the invention.

### EXAMPLE 9

### Evaluating Consistency of Dressing

The desired or expected consistency of a dressing may be evaluated by obtaining an average purge for the salad by weighing three individual salads without dressing and recording the measurements, heating each for 3.5 minutes, draining for 1 minute at a 45 degree angle, collecting moisture, weighing, adding to dressing mix, measuring viscosity and yield for each salad, and comparing to a standard.

1. A frozen salad entrée comprising a plurality of vegetables and a flavoring base, the flavoring base including a stabilizer useful for absorbing moisture released by the vegetables as they thaw.

2. The frozen salad entrée of claim 1, wherein the stabilizer comprises a gum.

3. The frozen salad entrée of claim 1, wherein the stabilizer comprises a starch.

4. The frozen salad entrée of claim 1, wherein the stabilizer comprises a gum and a starch.

5. The frozen salad entrée of claim 4, wherein the stabilizer includes approximately 0.5% to 7.5% gums, starches or both.

6. The frozen salad entrée of claim 1, wherein the flavoring base includes approximately 10% to 40% dry ingredients.

7. The frozen salad entrée of claim 1, wherein the frozen salad entrée is microwavable.

8. The frozen salad entrée of claim 4, wherein the frozen salad entrée is microwavable.

9. The frozen salad entrée of claim 4, wherein the stabilizer includes 0.2% to 1.5% gums.

10. The frozen salad entrée of claim 9, wherein the gums include guar, xanthan, and alginate.

11. The frozen salad entrée of claim 4, wherein the stabilizer includes 1% to 3% starch.

12. The frozen salad entrée of claim 11, wherein the starch includes a modified food starch.

13. A microwavable frozen salad entrée comprising a plurality of vegetables and a flavoring base, the flavoring base including a stabilizer useful for absorbing moisture released by the vegetables as they thaw, the stabilizer comprising approximately 0.5% to 7.5% gums, starches or both.

14. A method of preparing a frozen salad entrée comprising:
providing a frozen salad entrée comprising a plurality of vegetables and a flavoring base including a stabilizer; and
heating the salad entrée to a temperature of less than approximately 125° F., wherein the stabilizer absorbs moisture released by the vegetables as they thaw.

15. The method of claim 14 wherein the frozen salad entrée is heated by microwaving the entrée for approximately 1 to 4.5 minutes.

16. The frozen salad entrée of claim 15, wherein the stabilizer comprises a gum and a starch.

17. The frozen salad entrée of claim 16, wherein the stabilizer includes 0.2% to 1.5% gums.

18. The frozen salad entrée of claim 17, wherein the gums include guar, xanthan, and alginate.

19. The frozen salad entrée of claim 16, wherein the stabilizer includes 1% to 3% starch.

20. The frozen salad entrée of claim 19, wherein the starch includes a modified food starch.
